(19) United States
(12) Patent Application Publication
(10) Pub. No.: US 2016/0360744 A1
(43) Pub. Date: Dec. 15, 2016

(54) METHOD OF APPLYING AGRICULTURAL COMPOSITIONS

(71) Applicant: Winfield Solutions, LLC, Shoreview, MN (US)

(72) Inventors: Lillian C. Magidow, St. Paul, MN (US); Joe V. Gednalske, River Falls, WI (US); Gregory Keith Dahl, Eagan, MN (US); Eric P. Spandl, Shoreview, MN (US); Anthony Goede, Durand, IL (US)

(21) Appl. No.: 14/738,190

(22) Filed: Jun. 12, 2015

(51) Int. Cl. A01N 25/24; A01N 25/30; A01N 25/02; A01N 47/20; A01N 43/653

(52) U.S. Cl. CPC A01N 25/24; A01N 47/20; A01N 43/653; A01N 25/02; A01N 25/30

(57) ABSTRACT

Disclosed herein are methods of applying agricultural compositions including a pesticide, a fertilizer, or a combination of two or more of these, and about 0.1% v/v to 1.0% v/v of an adjuvant composition. The methods provide for aerial application of the agricultural compositions at wind speeds of up to 170 mph without substantially increasing the number of driftable droplets dispensed compared to the number of driftable droplets dispensed by applying the agricultural compositions without the adjuvant.

### TECHNICAL FIELD

The disclosure relates to aerial application methods for agricultural compositions including pesticides, fertilizers, or combinations thereof.

### BACKGROUND

Agricultural compositions include fertilizers or pesticides such as herbicides, insecticides, fungicides and other agents that control or eliminate unwanted pests. Adjuvant compositions are added to agricultural compositions in order to enhance the effectiveness of the compositions. Typically, agricultural spray adjuvants are not themselves active in the compositions. Instead, the adjuvants modify some property of the spray solution, which improves the ability of the pesticide to penetrate, target or protect the target organism. Among the typical types of ingredients used are surfactants, emulsifiers, oils and salts. Each of these ingredients, and others, modifies the spray solution itself to improve such properties as spreading, penetration, droplet size or other characteristics.

Adjuvants are included in a formulation with a pesticide or are added separately to a tank. When they are included in the pesticide formulations themselves, they are called “in-can” adjuvants. Adjuvants may also be added separately when the spray solution is being prepared. In this case, the adjuvant is called a “tank mix” adjuvant. In some cases, when delivered in-can, adjuvants are quite effective. However, because of the limited space in a pesticide formulation, not all necessary adjuvants are suitably included in-can. Thus, the addition of tank mix adjuvants is necessary in some cases to optimize performance of the pesticide.

Agricultural spray adjuvants do not reduce the amount of pesticide or fertilizer needed below the recommended use rate on a label. Rather, the adjuvants are used to enhance the performance of the level of pesticide or fertilizer that is used. In some cases the adjuvants give more consistent performance and may even make up for underperformance under certain conditions. Adjuvants can increase penetration of droplets into the plant canopy, or increase evaporation time, increasing the proportion of droplets making it to the target site of action, providing improved pest control.

The use of agricultural adjuvants, while beneficial to performance of agricultural compositions, presents an issue for agricultural compositions applied via aerial spray. Aerial application of liquids tends to produce very fine droplets, which occur when high effective wind speed at the nozzle shears the stream of liquid into droplets as it exits. The use of adjuvants tends to lower the median droplet size of sprays used in aerial applications, because adjuvants tend to lower the surface tension of waterborne agricultural compositions. This effect is further increased by users that exceed the recommended aerial speed during application, which increases shear forces and leads to even greater amounts of driftable droplets.

The shear presented by high wind speeds at the nozzle divides the liquid stream into droplets that quickly attain spherical or nearly spherical shape. Droplets having a diameter smaller than about 105 μm are considered “driftable” according to ASTM E2798-11. That is, the movement of such droplets is more dependent on the irregular movement of turbulent air than on gravity, leading to substantial particle drift. Particle drift is the actual movement of spray particles away from the target area prior to falling on a canopy or soil element. Many factors affect this type of drift, but the most important is the initial size of the droplet. Small droplets fall through the air slowly, and are carried farther by air movement.

Droplet drift results in many serious issues including but not limited to product loss, lower rate of application than intended leading to loss of efficacy, damage to susceptible off-target sites, environmental contamination such as water pollution and, in some instances, liability for trespass when drifting droplets land on another's property. Thus, there is a need in the industry for methods of aerial application of agricultural compositions that deliver low levels of driftable droplets, while retaining the performance of the applied materials in the targeted area.

### SUMMARY

Disclosed herein are methods of dispensing a solution from a nozzle, the nozzle rated for between 0.2 and 3.0 gallons per minute spray at 40 psi and situated at an angle of about 0° to 23° from the horizontal, the wind speed present at the nozzle opening being about 130 miles per hour to 170 miles per hour, the pressure proximal to the nozzle opening being about 30 psi to 60 psi, wherein the solution includes an agricultural composition including a pesticide, a fungicide, an herbicide, a fertilizer, or a combination thereof and about 0.1% v/v to 1.0% v/v of an adjuvant composition, the method including dispensing the agricultural composition, wherein the number of driftable droplets dispensed is increased less than about 30% over the agricultural composition without the adjuvant composition dispensed under the same conditions. In some embodiments, the number of driftable droplets dispensed is decreased over the agricultural composition without the adjuvant composition dispensed under the same conditions.

In some embodiments the dispensing is carried out by an aircraft flying about 5 to 20 feet above a selected plant canopy or soil surface. In some embodiments, the dispensing is accomplished by an array of about 2 to 100 nozzles, wherein the rate of dispensing is about 0.5 gallons per acre to 10 gallons per acre total. In some embodiments, the nozzle is a flat fan type nozzle or a hollow cone type nozzle. In some embodiments, the air speed is about 150 miles per hour to 170 miles per hour. In some embodiments, the pressure proximal to the nozzle opening is about 40 psi to 60 psi. In some embodiments, the nozzle is situated at an angle of about 8° to 23° from the horizontal.

Also disclosed herein are methods of aerial application of a solution, the method including: flying an aircraft over a selected plant canopy or soil surface at a height of about 8 to 12 feet above the canopy or surface at an airspeed of about 150 miles per hour to 170 miles per hour; and dispensing a solution from about 2 to 100 nozzles situated on the aircraft, the nozzles situated to dispense the solution at about 8° to 23° from the horizontal, wherein the dispensing is accomplished at a rate of about 0.5 gallons per acre to 10 gallons per acre total at a pressure of about 40 psi to 60 psi, the solution comprising a pesticide, a fertilizer, or a combination thereof and 0.1% v/v to 1.0% v/v of an adjuvant.

Additional advantages and novel features of the invention will be set forth in part in the description that follows, and in part will become apparent to those skilled in the art upon examination of the following, or may be learned through routine experimentation upon practice of the invention.

### BRIEF DESCRIPTION OF THE DRAWINGS

FIGS. 1A, 2A, 3A, 4A, 5A and 6A are a series of photographs of a 1 μL droplet of water falling 7.62 cm onto a wax paper surface, taken at a selected set of intervals.

FIGS. 1B, 2B, 3B, 4B, 5B and 6B are photographs of a 1 μL droplet of an adjuvant solution falling 7.62 cm onto a wax paper surface, taken at a selected set of intervals.

### DETAILED DESCRIPTION

Although the present disclosure provides references to preferred embodiments, persons skilled in the art will recognize that changes may be made in form and detail without departing from the spirit and scope of the invention. Reference to various embodiments does not limit the scope of the claims attached hereto. Additionally, any examples set forth in this specification are not intended to be limiting and merely set forth some of the many possible embodiments for the appended claims.

Definitions

As used herein, the term “agricultural composition” means a substantially uniformly dissolved or dispersed combination of one or more pesticides or fertilizers, and an adjuvant composition in water. The agricultural compositions are suitable for spray type applications. In embodiments, the agricultural composition is a solution, an emulsion, or a dispersion.

As used herein, the term “adjuvant” or “adjuvant composition” means a compound or combination of compounds that, when added to a solution, emulsion, or dispersion of pesticides or fertilizers in water, improves the ability of the pesticide to penetrate, target or protect the target organism by, e.g. improving spreading or penetration of the agricultural solution compared to the solution without the adjuvant composition.

As used herein, the term “drift” or “spray drift” means the movement of droplets of agricultural compositions outside the target area occurring at the time of application or proximal to the time of application; it does not include off-target application, movement of composition components after contact with the targeted canopy or soil, or the like.

As used herein, the term “driftable” as applied to agricultural compositions means liquid particulates, or droplets, of the compositions that are substantially spherical in shape and having a diameter of about 105 μm or less. The diameter is generally referred to herein as “droplet size.”

As used herein, the term “about” modifying, for example, the quantity of an ingredient in a composition, concentration, velocity, volume, yield, flow rate, pressure, droplet size, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through human error and approximation; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

As used herein, the word “substantially” modifying, for example, the type or quantity of an ingredient in a composition, a property, a measurable quantity, a method, a position, a value, or a range, employed in describing the embodiments of the disclosure, refers to a variation that does not affect the overall recited composition, property, quantity, method, position, value, or range thereof in a manner that negates an intended composition, property, quantity, method, position, value, or range. Intended properties include, solely by way of nonlimiting example thereof, surface tension; intended positions include, solely by way of nonlimiting example thereof, the angle of dispensing the solutions. The effect on methods that are modified by “substantially” include, solely by way of nonlimiting example thereof, the effect of variable wind speed on the portion of fine droplets dispensed, wherein the manner or degree of the effect does not negate one or more intended outcomes; and like proximate considerations. Where modified by the term “substantially” the claims appended hereto include equivalents to these recitations.

Overview

Adjuvants used in the agricultural compositions almost universally lower the surface tension of the composition compared to the surface tension without the adjuvants. In some embodiments, addition of tank mix adjuvants also lowers the median droplet size of sprays used in aerial applications. Additionally, application at high wind speeds tends to lower to the average droplet size of sprays used in aerial application. For this reason, speed ranges are indicated on the labels of compositions intended for aerial application. Speeds above 140 mph are typically contraindicated on such labels. However, many users in fact exceed the recommended speed flown during aerial application, which increases the shear and thus lowers the droplet size even further, and concomitantly increases the portion of droplets having a droplet size of 105 μm or less.

Further, even when flying in compliance with the recommended speeds of application, the actual wind speed to which the stream of agricultural composition is subjected upon exiting a nozzle varies with the weather conditions, i.e. native wind speed at the time of exit. Other environmental factors, such as temperature and humidity (affecting evaporation of the water during the trip from nozzle to target) also play a role in determining ultimate droplet size prior to a droplet reaching its final destination atop a canopy or soil.

Described herein are methods of dispensing agricultural compositions applied by aircraft flying at low altitudes and dispensing the compositions from an onboard tank fluidly connected to an array of nozzles. In particular, it has been found that the methods described herein enable the spray application of agricultural compositions even at very high wind speeds, such as 135 mph to 170 mph, while providing an increase of 30% or less in the number of driftable droplets, that is, droplets having a droplet size of 105 μm or less, when the same spray conditions are applied to the same agricultural composition without an adjuvant. It has been found that a combination of high pressure and low application rate of the agricultural compositions minimizes the amount of droplets having a size of 105 μm or less in such application conditions, when employed with agricultural compositions including adjuvant compositions added to the agricultural compositions at low levels, such as 0.1% v/v to 1.0% v/v.

Thus, the methods described here are usefully employed to lower the percentage of fine droplets dispensed during aerial applications of agricultural compositions, wherein the exact proportion of fine droplets varies according to such factors as those described above. It has been found that even at low use levels, the adjuvants retain a high efficacy in their intended uses including wetting, spreading, and the like.

Compositions

The agricultural compositions applied by agricultural aircraft include at least a pesticide, a fertilizer, or a combination thereof, and about 0.1% v/v to 1.0% v/v of an adjuvant composition. The adjuvant compositions employed in the agricultural compositions are tank mix adjuvants, that is, adjuvants that are supplied separately from pesticide or fertilizer compositions and are added to the pesticide or fertilizer compositions, optionally with additional water and/or other additives, to form the sprayable agricultural composition having about 0.1% v/v to 1.0% v/v of the adjuvant incorporated therein.

The pesticides and fertilizers usefully employed in conjunction with the methods set forth herein are not particularly limited. Any pesticide, fertilizer, or combination thereof suitable for spray type applications are usefully employed with the methods disclosed. Further, in some embodiments, pesticides, fertilizers, or combinations thereof not previously employed in aerial spray applications due to the formation of undue levels of fine droplet formation are useful when applied using the methods described in conjunction with the adjuvant levels described.

Pesticides usefully employed in the agricultural compositions include fungicides, herbicides, insecticides, and plant growth regulators. Examples of fungicides useful in conjunction with the methods disclosed herein include those selected from the group including Group 11 fungicides, pyraclostrobin, azoxystrobin, chlorothalonil, boscalid, mancozeb, strobilurin, triphenyltin hydroxide, or combinations of two or more thereof; and combinations of Group 11 fungicides with fungicides from other groups such as Group 3 and Group 7. Some examples of commercially available fungicides are PRIAXOR® XEMIUM®, a suspension concentrate blend of fluxapyroxad and pyraclostrobin available from BASF® SE of Ludwigshafen am Rhein, Germany; HEADLINE®, an emulsifiable concentrate of pyraclostrobin available from BASF®; HEADLINE® SC, a suspension concentrate of pyraclostrobin available from BASF®; HEADLINE® AMP for corn, a blend of pyraclostrobin and metconazole, available from BASF®; QUILT® and QUILT® XCEL®, a blend of azoxystrobin and propiconazole available from Syngenta International AG of Basel, Switzerland; and STRATEGO® and STRATEGO® YLD, a blend of propiconazole and trifloxystrobin available from Bayer AG of Leverkusen, Germany.

Examples of herbicides useful in agricultural compositions in conjunction with the methods disclosed herein include those selected from groups including EPSP inhibitors such as glyphosate; glutamine synthetase inhibitors such as glufosinate; accase inhibitors such as tralkoxydim, quizalofop, diclofop, clodinafop, sethoxydim, fenoxaprop, and clethodim; membrane disruptors such as difenzoquat and paraquat; emergence inhibitors such as triallate; mitosis inhibitors such as pendimethalin, trifluralin, and ethalfluralin; ALS inhibitors such as imazamethabenz, sulfesulfuron, flucarbazone, metsulfuron, triasulfuron, tribenuron, thifensulfuron, chlorsulfuron, prosulfuron, imazapic, imazathapyr, and imazamox; growth regulators such as dicamba, 2,4-D, clopyralid, quinclorac, fluoxypyr, and picloram; and photosynthesis inhibitors such as pyridate and bromoxylnil; and combinations of two or more of these.

Examples of insecticides useful in agricultural compositions in conjunction with the methods disclosed herein include those selected from the groups including carbamates such as methomyl, thiodicarb, carbaryl, and oxamyl; organophosphates such as terbufos, Diazinon, naled, Dimethoate 4EC, disulfoton, phosmet, chlorpyrifos, Malathion, oxydemetonmethyl, ethoprop, methamidophos, acephate, methyl parathion, and phorate; organochlorides such as endosulfan; pyrethroids such as permethrin, esfenvalerate, beta-cyfluthrin, bifenthrin, fenpropathrin, gamma-cyhalothrin, lambda-cyhalothrin, and pyrethrins; neonicotinyls such as thiamethoxam, imidacloprid, acetamiprid, clothianidin, thiamethoxam, and dinotefuran; insect nerve poisons such as abamectin, indoxacarb, flonicamid, chlorantraniliprole, pymetrozine, emamectin benzoate, spinetoram, spinosad, and flubendiamide; insect growth regulators such as buprofezin, diflubenzuron, pyriproxyfen, (S)-methoprene, methoxyfenozide, pyriproxyfen, azadirachtin, novaluron, cyromazine, and etoxazole; and other insecticides such as bifenazate, Bacillus thuringiensis, Cryolite, acequinocyl, potassium salts of fatty acids, spirotetramat, Beauveria, spiromesifen, fenpyroximate, synthetic extract of Chenopodium ambrosioides, mineral oil, and Sulfur 6L; and combinations of two or more of these.

Examples of fertilizers useful in agricultural compositions in conjunction with the methods disclosed herein include those selected from the group of including foliar micronutrients, that is, soluble sources of nitrogen, phosphorus, and potassium, and the like. Blends of fertilizers with one or more pesticides, blends of two or more pesticides, in embodiments further blended with one or more fertilizers, are also suitable employed.

In embodiments, the amount of adjuvant suitably used in the agricultural compositions is present at a concentration of about 0.10% v/v to 1.00% v/v, for example about 0.10% v/v to 0.95% v/v, or about 0.10% v/v to 0.90% v/v, or about 0.10% v/v to 0.85% v/v, or about 0.10% v/v to 0.80% v/v, or about 0.10% v/v to 0.75% v/v, or about 0.10% v/v to 0.70% v/v, or about 0.10% v/v to 0.65% v/v, or about 0.10% v/v to 0.60% v/v, or about 0.10% v/v to 0.55% v/v, or about 0.10% v/v to 0.50% v/v, or about 0.10% v/v to 0.45% v/v, or about 0.10% v/v to 0.40% v/v, or about 0.10% v/v to 0.35% v/v, or about 0.10% v/v to 0.30% v/v, or about 0.10% v/v to 0.25% v/v, or about 0.10% v/v to 0.20% v/v, or about 0.15% v/v to 0.50% v/v, or about 0.20% v/v to 0.50% v/v, or about 0.25% v/v to 0.50% v/v.

Adjuvants suitably used in the agricultural compositions are tank mix adjuvants. Suitable tank mix adjuvants include one or more oils and one or more surfactants. In embodiments, one or more components of the adjuvant composition are biomass based, plant based, or both. Suitable oils include paraffin oils, vegetable oils and modified vegetable oils, and polyol modified fatty acid esters including sorbitol-modified fatty acid esters. Suitable surfactants include both ionic and nonionic surfactants, wherein suitable nonionic surfactants include alkylphenol ethoxylates, ethoxylated paraffin oils, polyethoxylated sorbitan fatty acid esters, ethoxylated alkyl phosphate esters, and ethoxylated vegetable oils such as ethoxylated soybean oil, ethoxylated corn oil, ethoxylated sunflower oil, ethoxylated canola oil, and the like. Mixtures of ethoxylated and propoxylated adducts of the foregoing are also suitably employed in some embodiments. Other compounds suitably employed in tank mix adjuvants include polymers to increase extensional or shear viscosity, such as guar gum; and polyhydroxylated compounds including sugars, glycols, C1-C8 alcohols, and lecithin. Combinations of any of the above are suitably employed.

In some embodiments, the adjuvant is a mixture of paraffin oils and a surfactant, such as an ethoxylated surfactant. In some embodiments, the adjuvant is a mixture of modified vegetable oil, polyoxyethylene sorbitan fatty acid ester, and vegetable oil. A suitable adjuvant containing the foregoing admixture includes INTERLOCK®, sold by WinField Solutions, LLC of Shoreview, Minn. In some embodiments, the adjuvant further includes ethoxylated soybean oil. One such adjuvant is MASTERLOCK®, sold by WinField Solutions, LLC of Shoreview, Minn.

Indicated ground spray levels of adjuvants generally range from about 1% v/v to 2.5% v/v or even higher, in some instances as high as 5% v/v depending on the particular adjuvant composition and rate of application per acre. Such levels are indicated based on the most efficient and effective levels to achieve the desired effect at an acceptable price point. Desired effects include wetting, spreading, penetration of leaves, penetration of canopy, minimization of driftable droplets, and the like. The label-indicated use level of adjuvants for aerial applications is generally about 0.5% v/v to as high as 1.5% v/v, again depending on the rate of application per acre. However, high air speeds employed during application, for example 100 mph and greater, causes droplets exiting the nozzle to shear or shatter, causing an increase in driftable droplets.

It has been found that by using adjuvants at low levels, such as about 0.1% v/v to 1.0% v/v, or about 0.1% v/v to 0.50% v/v, or about 0.1% v/v to 0.25% v/v in agricultural compositions, combined with the methods outlined below, that the proportion of driftable droplets during aerial application at speeds of 135 mph to 170 mph is increased 30% or less over the proportion of driftable droplets that are formed when the agricultural compositions without adjuvant are applied under the same conditions. Furthermore, we have found that these low levels of adjuvants provide substantially the same benefit as higher levels—such as the more typical use levels of 1% v/v to 5% v/v—in terms of their intended effect of canopy penetration, leaf penetration, wetting, spreading, and the like when applied aerially using the methods described below.

Adjuvants suitably employed in the agricultural compositions include those that, when added to water at levels of about 0.1% v/v to 1.0% v/v increase the number of droplets considered to be driftable droplets less than about 30% at wind speeds of about 135 mph to 170 when ejected from a nozzle positioned 8° to 23° from the horizontal, the pressure proximal to the nozzle opening being about 30 psi to 60 psi. Adjuvants suitably employed in the agricultural compositions include those containing biomass based components such as vegetable oils, modified vegetable oils, ethoxylated vegetable oils, ethoxylated sorbitan fatty acid esters, or combinations of two or more of these. Other adjuvants suitably used include paraffin oils and one or more surfactants.

Methods of Application

The agricultural compositions having 0.1% v/v to 1.0% v/v adjuvant compositions are aerially applied to target agricultural surfaces including plant canopies and soil surfaces. Examples of agricultural surfaces include farmland, range, pastureland, mosquito control areas, or forested areas. By employing a method of aerial application of an agricultural composition as disclosed below, wherein the agricultural composition includes 0.1% v/v to 1.0% v/v of an adjuvant, the proportion of driftable droplets dispensed is increased less than 30% when compared to dispensation of the same agricultural composition without the adjuvant. However, the performance characteristics imparted by the adjuvant upon contact with the targeted agricultural area is substantially the same as observed for ground spraying the agricultural composition having greater than 1.0% v/v of the adjuvant.

Aircraft suitably used in conjunction with the methods of aerial application described herein are agricultural aircraft, that is, aircraft built or converted for agricultural use—usually aerial application of pesticides (crop dusting) or fertilizer (aerial topdressing); in these roles they are referred to as “crop dusters” or “top dressers”. Agricultural aircraft are also used for hydroseeding. The most common agricultural aircraft are fixed-wing airplanes. Helicopters are also used. Most agricultural aircraft have piston or turboprop engines, but the use of jet engines is known. Use of drone aircraft is routinely employed in Japan for crop dusting and is likely to be widely adopted in the future in the United States, both for crop dusting and aerial topdressing. Due to cost savings realized, drone use for aerial application of agricultural compositions will likely continue to globally.

In embodiments, the agricultural aircraft flies about 5 to 20 feet above a selected plant canopy or soil surface during the aerial application. In some embodiments, the agricultural aircraft flies about 8 to 12 feet above a selected plant canopy or soil surface during the aerial application.

Agricultural aircraft suitable for delivering the agricultural compositions described herein are equipped with at least a tank for holding a selected amount of an agricultural composition, wherein the tank is fluidly connected to an array of nozzles situated on the exterior of the aircraft. In some embodiments, the aircraft is an airplane or drone having fixed, substantially horizontal wings and the nozzles are arrayed along the wings. In other embodiments, the nozzles are arrayed on the exterior surface of the aircraft fuselage. In embodiments, the nozzle array includes between about 2 to 100 nozzles, each nozzle fluidly connected to the tank and disposed at an angle suitable for dispensing during flight. A pump or other mechanism for applying a selected and controllable pressure inside the tank and proximal to the nozzle orifices is provided in embodiments. In the descriptions that follow, some discussions are directed towards nozzle arrays and some towards single nozzles; it will be understood that in general, principles applicable to one nozzle also apply to an array of nozzles in context.

In embodiments, the wind speed present at the nozzle opening, that is, the speed of the aircraft on a windless day, is about 100 miles per hour to 170 miles per hour, or about 110 miles per hour to 170 miles per hour, or about 120 miles per hour to 170 miles per hour, or about 125 miles per hour to 170 miles per hour, or about 130 miles per hour to 170 miles per hour, or about 135 miles per hour to 170 miles per hour, or about 140 miles per hour to 170 miles per hour, or about 145 miles per hour to 170 miles per hour, or about 150 miles per hour to 170 miles per hour, or about 125 mph to 160 mph, or about 130 mph to 160 mph, or about 135 mph to 160 mph, or about 140 mph to 160 mph, or about 145 mph to 160 mph, or about 150 mph to 160 mph. While it is not necessary for an agricultural aircraft to fly at speeds in this range, it is a feature of the present methods that such speeds are employed while dispensing a proportion of driftable droplets that is increased less than 30% when compared to dispensation of the same agricultural composition without the adjuvant. Generally, speeds above 140 mph are out of conformance with the indicated use conditions for current agricultural compositions. This is because the higher the speed of the aircraft, the higher the shear forces applied across the nozzles during application, and thus, the finer the average droplet size during application. However, use of the methods disclosed herein in conjunction with the agricultural compositions results in increases in driftable droplet number of about 30% or less, that is, 0% to 30%, or about 5% to 28%, or about 10% to 25%, or about 0% to 5%, or about 0% to 10%, or about 5% to 10%, or about 10% to 20%, or any other range between 0% and 30% in 1% increments, such as between 3% and 22%, or between 14% and 16%, and the like, compared to the number of driftable droplets formed under the same conditions with agricultural compositions without adjuvant, even in conjunction with wind speed of over 130 mph, such as 135 mph to 170 mph, or about 140 mph to 170 mph, or about 150 mph to 170 mph, or about 135 mph to 150 mph, or about 140 mph to 150 mph, or about 140 mph to 160 mph.

Further, in some embodiments, low levels of adjuvant, such as 0.1% v/v to 0.25% v/v adjuvant, reduce the number of driftable droplets formed during aerial application, when compared to the number of driftable droplets formed by the agricultural composition without adjuvant. Such effects are observed in some embodiments at wind speeds of about 100 mph to 150 mph, or about 110 mph to 150 mph, or about 120 mph to 150 mph, or about 120 mph to 140 mph, or about 120 mph to 135 mph.

The agricultural compositions are loaded into tanks on the agricultural aircraft, the aircraft being equipped with an array of nozzles fluidly connected to the tank and arranged to dispense the agricultural compositions during flight. Nozzle type, nozzle angle, pressure proximal to the nozzle, and rate of application (combination of nozzle opening size, pressure proximal to the nozzle, and viscosity of the agricultural compositions) are variables along with wind speed during dispensing. Nozzle types useful for dispensing include those rated for between 0.2 and 3.0 gallons per minute spray at 40 psi. In some embodiments, the nozzle is a flat fan type nozzle or a hollow cone type nozzle. Any of the nozzle designs conventionally employed for aerial spray applications are suitably employed that lie within this range of application rates. Table 1 shows information about the droplet size of water, dispensed from a sampling of some representative nozzles at 120 miles per hour (mph), where VMD is the droplet size at which one-half the spray volume consists of large droplets and one-half consists of smaller droplets, GPM is gallons per minute, and PSI is pressure applied to the system bearing the nozzle, thus, pressure proximate to the nozzle during spray.

TABLE 1
Effect of nozzle type and angle from horizontal on water sprayed at
120 mph. (Reproduced from Sumner, P., “Managing Aerial Spray Drift”,
ENG96-006, The University of Georgia and Ft. Valley State College,
the U.S. Department of Agriculture and Counties of the state
Cooperating, March 1996)

| | | | VMD, | % <100 | % <200 |
|---|---|---|---|---|---|
| Nozzle | PSI | GPM | μm | μm | μm |
| D6 | 40 | 1.05 | 697 | 0.05 | 0.60 |
| ACCU-FLO; 32 | 40 | 1.90 | 409 | 0.14 | 1.95 |
| tubes | | | | | |
| M.L. Tips No. 6 | 40 | 1.08 | 718 | 0.11 | 1.49 |
| Plastic | | | | | |
| 6510 | 40 | 0.93 | 397 | 0.08 | 2.58 |
| D6-46 | 40 | 0.96 | 423 | 0.06 | 1.59 |
| ⅛ B5-5 Whirljet | 40 | 0.84 | 325 | 0.29 | 5.30 |
| TK5 Floodjet | 40 | 0.91 | 339 | 0.18 | 5.26 |
| Nylon CP 0.078, | 40 | 0.97 | 403 | 0.09 | 2.07 |
| 30° Deflection | | | | | |
| Nylon CP 0.078, | 40 | 0.97 | 321 | 0.37 | 7.64 |
| 60° Deflection | | | | | |
| Nylon CP 0.078, | 40 | 0.97 | 273 | 1.11 | 13.15 |
| 90° Deflection | | | | | |
| REG LO JET | 40 | 0.98 | 348 | 0.31 | 7.20 |
| 0.078-45° | | | | | |
| A&C Roto - D7 - | 40 | 1.12 | 319 | 1.19 | 7.94 |
| 80 Mesh Screen | | | | | |

In embodiments, the dispensing configurations available for nozzle arrays include a variable orientation that ranges between substantially horizontal, defined as 0°, wherein the stream of agricultural composition is directed toward the trailing end of the aircraft during flight; to substantially vertical, defined as 90°, wherein the dispensed stream is directed toward the ground during flight. As can be seen from the information in Table 1, a significant impact on the amount of driftable droplets from any nozzle is realized by changing the angle of spray.

Referring to the Nylon CP 0.078 data in Table 1, the difference in the amount of driftable droplets generated at deflection of 30°, 60°, and 90° is significant. The difference in the number of droplets having droplet size of less than 100 μm increases more than an order of magnitude in changing the angle of deflection from 30° to 90°. In embodiments, the nozzle angle employed in the methods described herein is less than 30°, or about 8° to 23°, or substantially 8° from horizontal. Slight variations, for example due to the angle of the agricultural aircraft with respect to actual horizontal during flight, are expected.

Pressure proximal to the nozzle also influences the formation of the droplets. The agricultural composition emerges from the nozzle in a thin sheet, and droplets form at the edge of the sheet. According to convention, higher pressure causes the sheet to be thinner, and the sheet breaks up into smaller droplets. Thus, conventional understanding predicts that higher fluid pressure proximal to the nozzle causes an increase in the amount of driftable droplets, that is, droplet sizes of 105 μm or less. However, we have found that use of higher pressure proximal to the nozzle leads to decreased amounts of driftable droplets. Thus, the present method contemplates pressure proximal to the nozzle of about 30 psi to 60 psi, or about 40 psi to 60 psi, or about 50 psi to 60 psi. Without wishing to be bound by theory, we believe that the droplets experience reduced shear when the pressure differential between the nozzle interior and the external environment is reduced.

The pressures employed in the methods are used in conjunction with total application rates of the agricultural compositions of about 0.5 gallons per acre to 10 gallons per acre, delivered by an array of 2 to 100 nozzles, or about 5 to 100, or about 8 to 100, or about 10 to 100, or about 20 to 100, or about 30 to 100, or about 40 to 100, or about 2 to 80, or about 2 to 60, or about 2 to 40, or about 10 to 70, or about 10 to 50, or about 20 to 70, or about 20 to 60, or about 30 to 60 nozzles. Suitable application rates include, for example, about 0.5 gallons per acre to 10 gallons per acre, or about 0.5 gallons per acre to 8 gallons per acre, or about 0.5 gallons per acre to 6 gallons per acre, or about 0.5 gallons per acre to 4 gallons per acre, or about 0.5 gallons per acre to 3 gallons per acre, or about 1 gallon per acre to 10 gallons per acre, or about 1 gallon per acre to 8 gallons per acre, or about 1 gallon per acre to 6 gallons per acre, or about 1 gallon per acre to 4 gallons per acre.

By employing a disclosed method of aerial application of an agricultural composition, wherein the agricultural composition includes 0.1% v/v to 0.5% v/v of an adjuvant, the proportion of driftable droplets dispensed is increased less than 30% when compared to dispensation of the same agricultural composition without the adjuvant. However, the performance characteristics imparted by the adjuvant upon contact of the agricultural composition with the targeted agricultural area is substantially the same as observed for ground spraying the agricultural composition having greater than 1.0% v/v of the adjuvant. By performance characteristics, it is meant that the biological and physical effects desired from the agricultural compositions are equivalent to the effects achieved by aerial application observed in corresponding ground applications.

In a representative embodiment, the method includes flying an aircraft over a selected plant canopy or soil surface at a height of about 5 to 20 feet above the canopy or surface at an airspeed of about 135 miles per hour to 170 miles per hour; and dispensing a solution from about 2 to 100 nozzles situated on the aircraft, the nozzles situated to dispense the solution at about 0° to 23° from the horizontal, wherein the dispensing is accomplished at a rate of about 0.5 gallons per acre to 10 gallons per acre, at a pressure of about 30 psi to 60 psi. In another representative embodiment, the method includes flying an aircraft over a selected plant canopy or soil surface at a height of about 5 to 20 feet above the canopy or surface at an airspeed of about 135 miles per hour to 170 miles per hour; and dispensing a solution from about 2 to 100 nozzles situated on the aircraft, the nozzles situated to dispense the solution at about 0° to 8° from the horizontal, wherein the dispensing is accomplished at a rate of about 0.5 gallons per acre to 5 gallons per acre, at a pressure of about 40 psi to 60 psi. In yet another representative embodiment, the method includes flying an aircraft over a selected plant canopy or soil surface at a height of about 8 to 12 feet above the canopy or surface at an airspeed of about 150 miles per hour to 170 miles per hour; and dispensing a solution from about 2 to 100 nozzles situated on the aircraft, the nozzles situated to dispense the solution at about 0° to 8° from the horizontal, wherein the dispensing is accomplished at a rate of about 0.5 gallons per acre to 5 gallons per acre, at a pressure of about 40 psi to 60 psi. In some such embodiments, the agricultural composition includes about 0.1% v/v to 1.0% v/v of an adjuvant composition. In other such embodiments, the agricultural composition includes about 0.1% v/v to 0.25% v/v of an adjuvant composition.

In some embodiments, a high speed wind tunnel is usefully employed to provide a controlled environment in which to measure average droplet size, proportion of driftable droplets, and the like while systematically varying nozzle type, nozzle angle, pressure, wind speed, and the like during dispensation of agricultural compositions. High speed wind tunnels are those capable of providing effective wind speeds of up to 170 mph or greater. In some embodiments as described herein, the methods of the invention and ranges provided reflect the measurements and values obtained in a wind tunnel. Variability of conditions encountered by aerial application may cause some of the effective ranges and values to fall outside the stated scope. However, it will be appreciated that such values fall substantially within the scope of the values reported herein, as defined by the compositions and methods employed.

### EXPERIMENTAL

All experiments were conducted using the University Of Nebraska High Speed Wind Tunnel (HSWT). Air speed inside the tunnel is selectively variable from 80 to 220 mph. Droplet size was analyzed using a Sympatec HELOS-KR laser particle size analysis system with R6 lens (available from Sympatec GmbH of Clausthal-Zellerfeld, Germany.

### EXAMPLE 1

A CP4008 flat fan nozzle (40° fan type nozzle, rated for 0.8 gal/minute at 40 psi; obtained from Transland, LLC of Wichita, Tex.) was mounted in the wind tunnel with the nozzle opening directed toward the trailing direction of the wind, the fan spread situated in a horizontal disposition, and the nozzle situated 18 inches from the tunnel ceiling in the center of the tunnel. The nozzle angle was set 8° from the horizontal. Temperature inside the wind tunnel was 76° F., relative humidity was 67-69%. Two ounces per gallon of HEADLINE® AMP fungicide (obtained from BASF® SE of Ludwigshafen am Rhein, Germany) was blended into water and this mixture was used to fill a tank connected to the nozzle. The tank was equipped with compressed air to apply a selected pressure to the tank.

Wind speed inside the tunnel was set to 170 mph. The mixture was dispensed from the nozzle at 40 psi, wherein the nozzle was set to deliver 0.8 gallons per minute. Droplet size was analyzed at 18 inches downwind of the nozzle release point. The percent of droplets having an average particle size of less than 105 μm was found to be 7.6%.

The experiment was repeated employing 2 ounces per gallon HEADLINE® AMP (1.56% v/v) plus 0.64 ounces per gallon (0.5% v/v) of MASTERLOCK®, an adjuvant obtained from WinField Solutions, LLC of Shoreview, Minn. and containing vegetable oil, modified vegetable oil, and polyoxyethylene sorbitan fatty acid ester. The percent of droplets having an average particle size of less than 105 μm was found to be 9.5%.

The experiment was repeated employing 2 ounces per gallon HEADLINE® AMP plus 0.64 ounces per gallon (0.5% v/v) of INTERLOCK®, an adjuvant obtained from Winfield Solutions, LLC and containing vegetable oil, modified vegetable oil, polyoxyethylene sorbitan fatty acid ester, and ethoxylated soybean oil. The percent of droplets having an average particle size of less than 105 μm was found to be 9.7%.

### EXAMPLE 2

The procedure of Example 1 was repeated for HEADLINE® AMP at 5 ounces per gallon, at 40 psi and 60 psi and employing variable amounts of adjuvant. Table 1 shows percent of droplets having an average particle size of less than 105 μm as a function of composition dispensed and pressure at the nozzle. Water without any additives was also run as a control. Table 1. Percent of droplets having an average particle size of less than 105 μm as a function of composition and pressure.

TABLE 1
Percent of droplets having an average particle size of less
than 105 μm as a function of composition and pressure.

| | | | % droplets having | |
|---|---|---|---|---|
| | Amount in water | | particle size <105 μm | |
| Component | oz/gal | % v/v | 40 psi | 60 psi |
| Water | n/a | n/a | 8.18 | 6.02 |
| HEADLINE ® AMP | 5 | 3.9 | 12.56 | 9.82 |
| (BASF ® SE of | | | | |
| Ludwigshafen am | | | | |
| Rhein, Germany) | | | | |
| HEADLINE ® AMP + | 5 + 1 | 3.9 + 0.78 | 13.45 | 10.98 |
| INTERLOCK ® | | | | |
| (WinField | | | | |
| Solutions LLC of | | | | |
| Shoreview, MN) | | | | |
| HEADLINE ® AMP + | 5 + 2 | 3.9 + 1.56 | 19.69 | 15.73 |
| MASTERLOCK ® | | | | |
| (WinField | | | | |
| Solutions LLC) | | | | |

### EXAMPLE 3

The procedure of Example 1 was repeated, except that measurements were made at 135 mph and employing two different nozzles, CP 4008 (40° fan type nozzle, rated for 0.8 gal/acre at 40 psi) and CP4010 (40° fan type nozzle, rated for 1.0 gal/acre at 40 psi), both obtained from Transland, LLC of Wichita, Tex. Additionally, instead of HEADLINE® AMP, three ounces per gallon (2.3% v/v) of HEADLINE® SC fungicide (obtained from BASF® SE of Ludwigshafen am Rhein, Germany) was blended into water and this mixture was used to fill the tank connected to the nozzle. The experiment was repeated using HEADLINE® SC fungicide plus the adjuvants indicated in Table 2. Table 2 shows percent of droplets having an average particle size of less than 105 μm as a function of composition dispensed and nozzle type.

TABLE 2
Percent of droplets having an average particle size of less than
105 μm as a function of composition dispensed and nozzle type.

| | | % droplets having | |
|---|---|---|---|
| | Amount in | particle size <105 μm | |
| | water | CP4008 | CP4010 |
| Component | % v/v | nozzle | nozzle |
| Water only | n/a | 7.5 | 7.6 |
| HEADLINE ® SC (BASF) | 2.3 | 11.5 | 10.1 |
| HEADLINE ® SC + | 2.3 + 0.8 | 12.3 | 11.8 |
| INTERLOCK ® (WinField | 2.3 + 1.6 | 13.3 | 12.2 |
| Solutions LLC) | | | |
| HEADLINE ® SC + | 2.3 + 0.25 | 9.8 | 10.1 |
| MASTERLOCK ® (WinField | 2.3 + 0.5 | 11.2 | 11.9 |
| Solutions LLC) | 2.3 + 1.0 | 13.0 | 13.3 |

### EXAMPLE 4

The procedure of Example 1 was repeated using HEADLINE® SC at 1.56% v/v in water, with and without 0.5% v/v of various adjuvants. Additionally, two different nozzles, CP 4008 (40° fan type nozzle, rated for 0.8 gal/acre at 40 psi) and CP2008 (20° fan type nozzle, rated for 0.8 gal/acre at 40 psi) were compared in the study. Table 3 shows percent of droplets having an average particle size of less than 105 μm as a function of composition dispensed and nozzle type.

TABLE 3
Percent of droplets having an average particle size of less than
105 μm as a function of composition dispensed and nozzle type.

| | | % droplets having | |
|---|---|---|---|
| | Amount in | particle size <105 μm | |
| | water | CP2008 | CP4008 |
| Component | % v/v | nozzle | nozzle |
| HEADLINE ® SC (BASF) | 1.56 | 6.7 | 7.6 |
| HEADLINE ® SC + | 1.56 + 0.5 | 8.7 | 9.5 |
| INTERLOCK ® (WinField | | | |
| Solutions LLC) | | | |
| HEADLINE ® SC + | 1.56 + 0.5 | 8.6 | 9.7 |
| MASTERLOCK ® (WinField | | | |
| Solutions LLC) | | | |
| HEADLINE ® SC + | 1.56 + 0.5 | 7.3 | 7.9 |
| VOLARE ® (Precision | | | |
| Laboratories, LLC of | | | |
| Waukegan, IL) | | | |

### EXAMPLE 5

A high-speed camera was set up to view droplets during ejection, impact, and subsequent wetting/spreading on a waxy surface to provide a visual analysis droplet behavior when droplets fall on plant leaves. A micropipette tip was positioned 7.62 cm (3 inches) above a substrate to eject 1 μL droplets of liquid onto a sheet of Marcal® 5101 Dry Waxed Patty Paper (obtained from Marcal Manufacturing, LLC of Elmwood Park, N.J.). The fall, impact, and subsequent wetting/spreading behavior of the droplets was captured in 800 photographs taken at 4000 frames/sec.

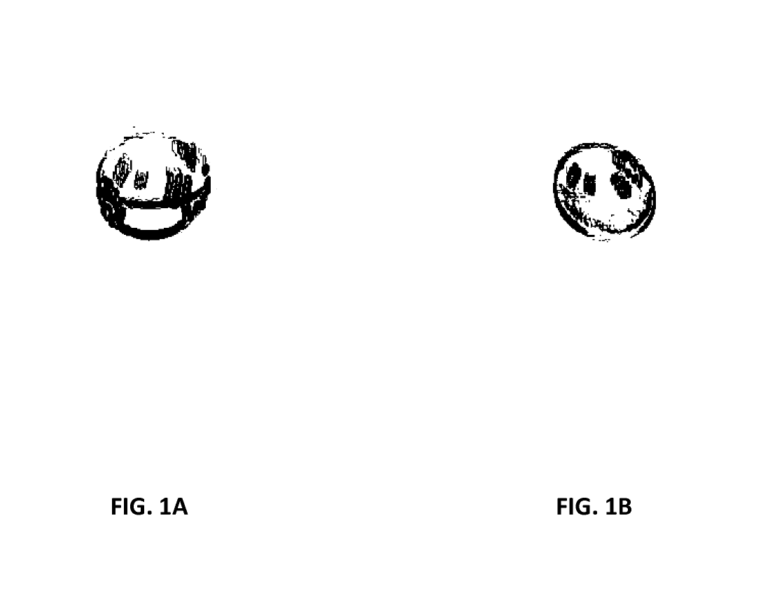

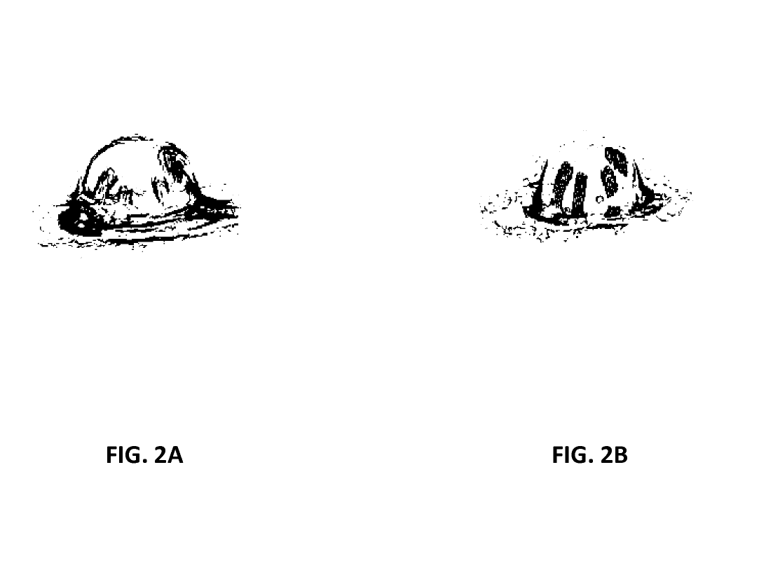

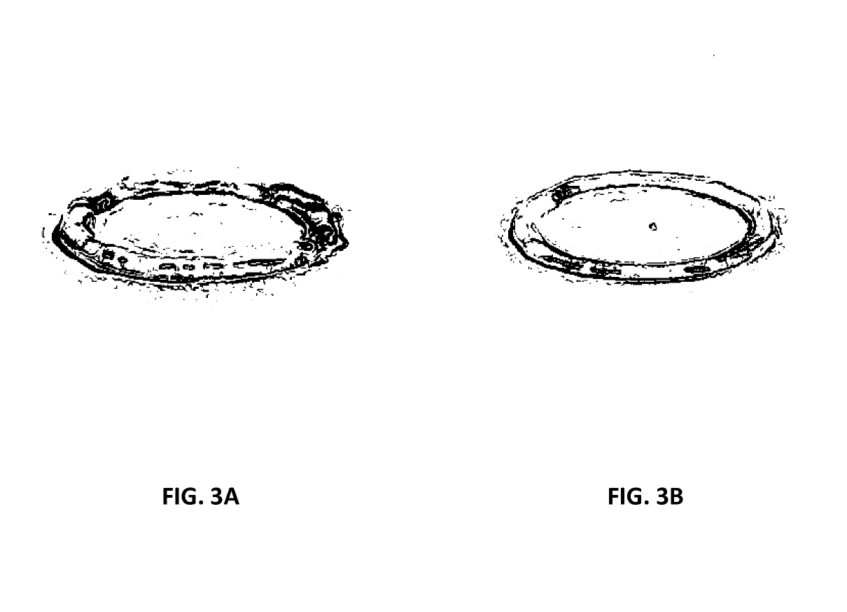

Tap water was ejected and filmed. Then a 0.31 v/v% solution of INTERLOCK® (obtained from WinField Solutions LLC of Shoreview, Minn.) in tap water was ejected and filmed. A series of photographs was selected at chosen intervals after ejection. Table 4 shows the correspondence of FIGS. 1A to 6A and 1B to 6B to ejection of the water droplet and INTERLOCK® solution droplet photographed at the indicated time interval after ejection.

TABLE 4
Correspondence of material ejected and time after
initiation of ejection to FIGS. 1A-6A and 1B-6B.

| Material Ejected, | Time After Ejection, | |
|---|---|---|
| 1 μL | second | FIG. |
| Water | 0.011 | 1A |
| | 0.016 | 2A |
| | 0.019 | 3A |
| | 0.029 | 4A |
| | 0.049 | 5A |
| | 0.086 | 6A |
| Water + 1.56 wt % | 0.011 | 1B |
| INTERLOCK ® | 0.016 | 2B |
| | 0.019 | 3B |
| | 0.029 | 4B |
| | 0.049 | 5B |
| | 0.086 | 6B |

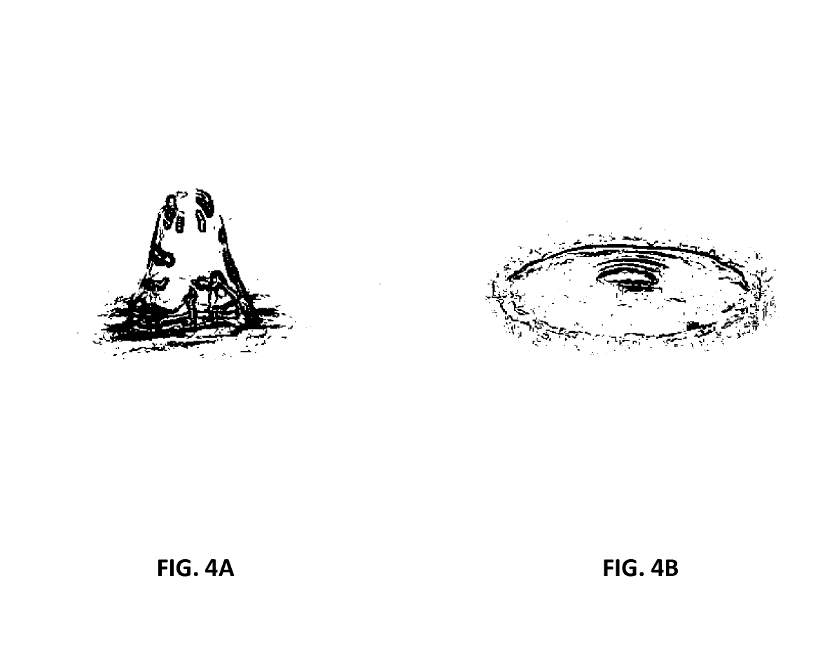

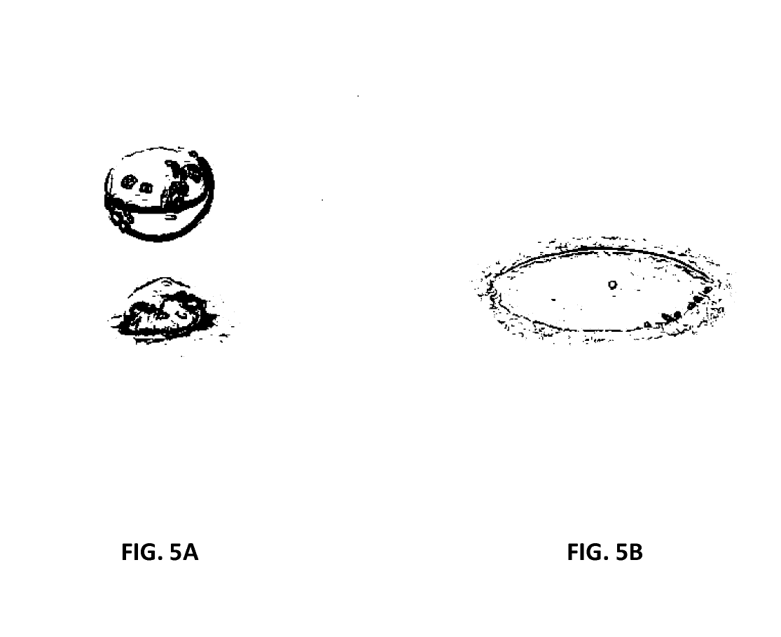

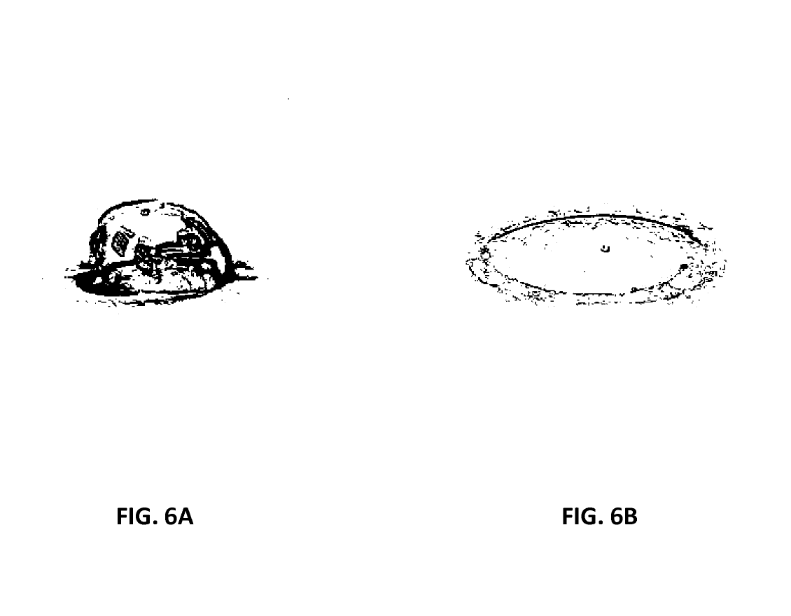

From an inspection of FIGS. 1A-3A and 1B-3B, it is apparent that the two droplets behave similarly during flight and initial impact. However, a comparison of FIGS. 4A and 4B reveals that the INTERLOCK® solution provides superior wetting on the wax paper surface, even at less than 1.0 v/v%. This can be further observed in FIGS. 5 and 6, wherein FIGS. 5B-6B show the superior wetting and spreading provided by 0.31 v/v% INTERLOCK® as compared to water in FIGS. 5A-6A.

The invention illustratively disclosed herein can be suitably practiced in the absence of any element which is not specifically disclosed herein. Additionally each and every embodiment of the invention, as described herein, is intended to be used either alone or in combination with any other embodiment described herein as well as modifications, equivalents, and alternatives thereof. In various embodiments, the invention suitably comprises, consists essentially of, or consists of the elements described herein and claimed according to the claims. It will be recognized that various modifications and changes may be made without following the example embodiments and applications illustrated and described herein, and without departing from the scope of the claims.

1. A method of dispensing a solution from a nozzle, the nozzle rated for about 0.2 to 3.0 gallons per minute at 40 psi and situated at an angle of about 8° to 23° from the horizontal, the wind speed present at the nozzle opening being about 135 miles per hour to 170 miles per hour, the pressure proximal to the nozzle opening being about 30 psi to 60 psi, wherein the solution comprises an agricultural composition comprising a pesticide, a fungicide, an herbicide, a fertilizer, or a combination thereof and about 0.1% v/v to 1.0% v/v of an adjuvant composition, the method comprising dispensing the agricultural composition from the nozzle, wherein the number of driftable droplets dispensed is increased less than 30% over the agricultural composition without the adjuvant composition dispensed under the same conditions.

2. The method of claim 1 wherein the dispensing is carried out by an aircraft flying about 5 to 20 feet above a selected plant canopy or soil surface.

3. The method of claim 2 wherein the dispensing is accomplished by about 2 to 100 nozzles, wherein the total rate of dispensing of the nozzles is about 0.5 gallons per acre to 10 gallons per acre.

4. The method of claim 2 wherein the plant canopy or soil surface comprises farmland, range, pastureland, a mosquito control area, or a forested area.

5. The method of claim 1 wherein the number of driftable droplets dispensed is increased about 0% to 20% over the same agricultural composition without the adjuvant composition.

6. The method of claim 1 wherein the number of driftable droplets dispensed is increased about 5% to 10% over the same agricultural composition without the adjuvant composition.

7. The method of claim 1 wherein the number of driftable droplets dispensed is decreased over the same agricultural composition without the adjuvant composition.

8. The method of claim 1 wherein the air speed is about 150 miles per hour to 170 miles per hour.

9. The method of claim 1 wherein the pressure proximal to the nozzle opening is about 40 psi to 60 psi.

10. The method of claim 1 wherein the nozzle is situated at an angle of about 8° from the horizontal.

11. The method of claim 1 wherein the agricultural composition comprises about 0.1% v/v to 0.25% v/v of the adjuvant composition.

12. The method of claim 1 wherein the dispensing is carried out in a wind tunnel.

13. The method of claim 1 wherein the solution comprises a fungicide selected from the group comprising pyraclostrobin, azoxystrobin, chlorothalonil, boscalid, mancozeb, strobilurin, triphenyltin hydroxide, or combinations of two or more thereof.

14. The method of claim 1 wherein the adjuvant comprises an oil and a surfactant.

15. The method of claim 14 wherein the oil and surfactant are biomass based.

16. The method of claim 15 wherein the adjuvant comprises modified vegetable oil, polyoxyethylene sorbitan fatty acid ester, and vegetable oil, and optionally ethoxylated soybean oil.

17. The method of claim 1 wherein the nozzle is a flat fan type nozzle or a hollow cone type nozzle.

18. A method of aerial application of a solution, the method comprising
flying an aircraft over a selected plant canopy or soil surface at a height of about 8 to 12 feet above the canopy or surface at an airspeed of about 150 miles per hour to 170 miles per hour; and
dispensing a solution from about 40 to 50 nozzles situated on the aircraft, the nozzles situated to dispense the solution at about 8° to 23° from the horizontal, wherein the dispensing is accomplished at a rate of about 0.5 gallons per acre to 2 gallons per acre at a pressure of about 40 psi to 60 psi, the solution comprising a pesticide, a fertilizer, or a combination thereof and 0.1% v/v to 1.0% v/v of an adjuvant.

19. The method of claim 18 wherein the adjuvant comprises modified vegetable oil, polyoxyethylene sorbitan fatty acid ester, and vegetable oil, and optionally ethoxylated soybean oil.
